(19) United States
(12) Patent Application Publication
(10) Pub. No.: US 2024/0203305 A1
(43) Pub. Date: Jun. 20, 2024

(54) ON-BOARD PROJECTION SYSTEM AND VEHICLE EMPLOYING SYSTEM

(71) Applicants: Futaijing Precision Electronics (Yantai) Co., Ltd., Yantai (CN); HON HAI PRECISION INDUSTRY CO., LTD., New Taipei (TW)

(72) Inventor: JHENG-JIE HE, New Taipei (TW)

(21) Appl. No.: 18/217,639

(22) Filed: Jul. 3, 2023

(30) Foreign Application Priority Data
Dec. 19, 2022 (CN) 202211633130.X

(51) Int. Cl. G09G 3/00; B60K 37/02

(52) U.S. Cl. CPC G09G 3/002; B60K 37/02; B60K 2370/334; G09G 2320/0626

(57) ABSTRACT

An on-board projection system that can adjust a display brightness of a projection image according to an interior environment of a vehicle comprises a vehicle terminal, a projection component, a vehicle entertainment system, a display component, and a sensing component. The vehicle terminal is communicated with the projection component, the vehicle entertainment system is communicated with the vehicle terminal and is further electrically connected to the projection component, the projection component is electrically connected to the display component. The display component is configured to display a projection image of the vehicle entertainment system, the sensing component is arranged on a side of the display component for detecting an interior environment of the vehicle. The projection component adjusts a display brightness of the projection image according to a detection result of the interior environment. The vehicle is also provided.

### FIELD

The subject matter herein relates to on-board projection systems.

### BACKGROUND

At present, when a passenger takes a long time in a vehicle, the passenger may use the central control screen or mobile device to watch video. While a screen size of the central control screen or the mobile device is general small, a viewing experience of the passenger is poor.

### BRIEF DESCRIPTION OF THE DRAWINGS

Many aspects of the disclosure can be better understood with reference to the following drawings. The components in the drawings are not necessarily drawn to scale, the emphasis instead being placed upon clearly illustrating the principles of the disclosure. Moreover, in the drawings, like reference numerals designate corresponding portions throughout the several views.

FIG. 1 is a block diagram of an on-board projection system according to an embodiment of the present application.

FIG. 2 is a schematic structural diagram of a projection component of the on-board projection system of FIG. 1.

FIG. 3 is a block diagram of a vehicle according to an embodiment of the present application.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures, and components have not been described in detail so as not to obscure the related relevant feature being described. Also, the description is not to be considered as limiting the scope of the embodiments described herein. The drawings are not necessarily to scale and the proportions of certain parts may be exaggerated to better illustrate details and features of the present disclosure. It should be noted that references to “an” or “one” embodiment in this disclosure are not necessarily to the same embodiment, and such references mean “at least one”.

Several definitions that apply throughout this disclosure will now be presented.

The term “coupled” is defined as connected or electrically connected, whether directly or indirectly through intervening components, and is not necessarily limited to physical connections. The connection can be such that the objects are permanently connected or releasably connected. The term “comprising,” when utilized, means “including, but not necessarily limited to”; it specifically indicates open-ended inclusion or membership in the so-described combination, group, series, and the like.

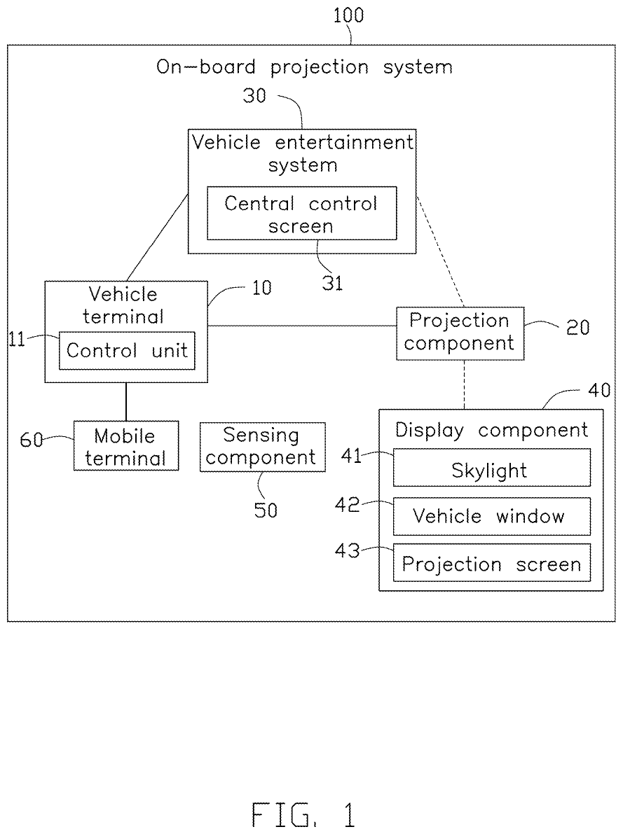

FIG. 1 illustrates one exemplary embodiment of an on-board projection system 100. The on-board projection system 100 comprises a vehicle terminal 10, a projection component 20, a vehicle entertainment system 30, a display component 40, a sensing component 50, and a mobile terminal 60. The vehicle terminal 10 is communicated with (wireless or wired communication) the projection component 20, and the vehicle entertainment system 30 is communicated with the vehicle terminal 10. The vehicle entertainment system 30 is coupled to the projection component 20, and the projection component 20 is coupled to the display component 40.

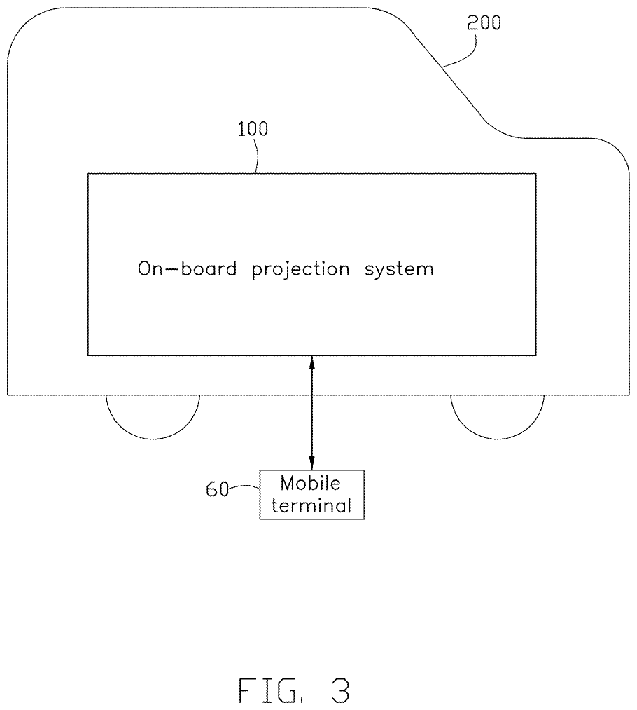

In one embodiment, as shown in FIG. 3, the mobile terminal 60 can be independent of the on-board projection system 100. That is, the on-board projection system 100 can comprise the vehicle terminal 10, the projection component 20, the vehicle entertainment system 30, the display component 40, and the sensing component 50.

The display component 40 is configured to display a projection image of the vehicle entertainment system 30, the projection image can be pictures or frames of a video. The sensing component 50 can be arranged on a side of the display component 40, and the sensing component 50 is configured to detect an interior environment of a vehicle 200 (as shown in FIG. 3). The projection component 20 can adjust a display brightness of the projection image according to a detection result of the interior environment detected by the sensing component 50. For example, the detection result of the interior environment comprises interior display brightness information of the vehicle 200, the projection component 20 adjusts the display brightness of the projection image according to the detection result of the interior environment, a viewing experience of the passenger can be improved.

The mobile terminal 60 is communicated with the vehicle terminal 10, the passenger can use the mobile terminal 60 to search the projection image, the projection image can be pre-stored in the mobile terminal 60 or downloaded from the internet network. The mobile terminal 60 can communicate with the projection component 20 through the vehicle terminal 10, and the mobile terminal 60 can transmit the projection image to the projection component 20 through the vehicle terminal 10, to achieve projecting the projection image. For example, the mobile terminal 60 can communicate with the vehicle terminal 10 through Bluetooth.

In one embodiment, the mobile terminal 60 can be a smart phone, a tablet, a laptop, a universal serial bus (USB) flash disk, etc., and the type of the mobile terminal 60 is not limited.

In one embodiment, the vehicle terminal 10 can comprise a microcontroller and a wireless module to realize an internet of vehicle function. The wireless module may comprise a fifth-generation (5G) communication unit and a wireless fidelity (Wi-Fi) communication unit.

In one embodiment, the vehicle terminal 10 may also use a cellular-vehicle to everything (C-V2X) to realize a vehicle extranet communication function, and transmits image data through an Ethernet to achieve an image function of the vehicle entertainment system 30. The image data can be transmitted in real time by the vehicle terminal 10 form the vehicle entertainment system 30 to the display component 40, and the image data can be displayed by the display component 40. The above data transmission process achieves a streaming function of the image data of an image to be projected.

The sensing component 50 is arranged in the vehicle 200 to sense the interior environment of the vehicle 200 at different time. A display brightness of the projection component 20 can be adjusted according to the interior environment detected by the sensing component 50, and a viewing experience of the passenger can be improved when the display component 40 displays the projection image. It can avoid some problems of hurting eyes of the passenger because of the interior environment of the vehicle is too dark causing the projection screen to look too bright, or because of the interior environment of the vehicle is too bright causing the projection screen to look too dim.

In one embodiment, the vehicle terminal 10 comprise a control unit 11, the control unit 11 is electrically connected to the projection component 20. The control unit 11 is configured to control the projection component 20 to suspend projecting the projection image of the vehicle entertainment system 30 according to a preset time rule.

In one embodiment, the preset time rule can be set by the passenger or the driver. The preset time rule may comprise a viewing time of the projection image. For example, the passenger can set a time for viewing the projection image is 60 minutes, and the control unit 11 will close the projection image after 60 minutes. It can avoid a problem of visual fatigue caused by long-time viewing when the passenger is a child. The passenger can also set a time for waiting to view the projection image, for example the time for waiting to view the projection image is 20 minutes, and the control unit 11 will display the projection image after 20 minutes. It can avoid a problem that the passenger may be busy with other affairs and cannot relax by view the projection image after 20 minutes.

In one embodiment, the display component 40 may comprises a skylight 41, a vehicle window 42 and a projection screen 43. The projection component 20 can display the projection image of the vehicle entertainment system 30 through at least one of the skylight 41, the vehicle window 42, and the projection screen 43. The sensing component 50 may be arranged on one side of the skylight 41 and/or the vehicle window 42. An arranged position of the sensing component 50 can be set and adjusted according to actual projection requirements, for example, the sensing component 50 can be arranged on a perimeter of a position to be projected. This application does not limit the arranged position of the sensing component 50.

In one embodiment, the projection component 20 can project the projection image to the skylight 41, the vehicle window 42, and the projection screen 43 at the same time, or project the projection image to any one or any two of the skylight 41, the vehicle window 42, and the projection screen 43. The vehicle window 42 may be a front window, a rear window, or a door window.

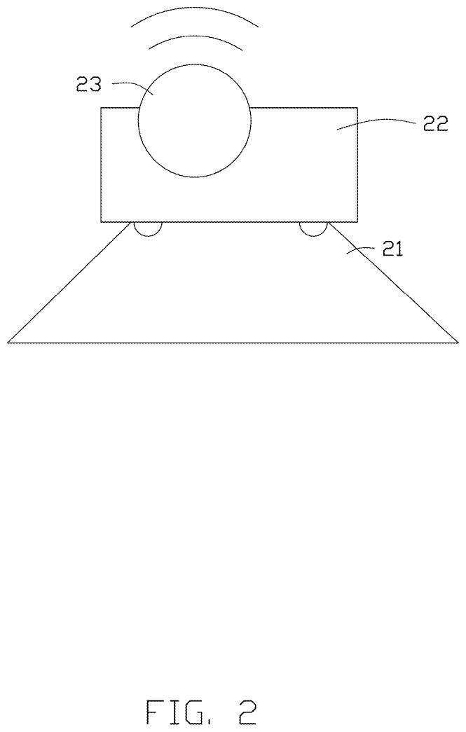

Referring to FIG. 2, the projection component 20 comprises a mounting base 21 and a projector 22. The projector 22 is arranged on the mounting base 21, and the mounting base 21 is detachably arranged the inside of the vehicle 200. For example, the projector 22 is fixed arranged on the mounting base 21.

In one embodiment, the projection component 20 can be arranged on any inside position of the vehicle according to actual viewing requirements, to enhance the viewing experience.

In one embodiment, the projector 22 can also be rotatably connected to the mounting base 21, a projection angle of the projector 22 can be adjusted by rotating the projector 22 after the mounting base 21 is arranged inside of the vehicle.

In one embodiment, the projector 22 may comprise multiple projection lenses with different sizes, and each of the multiple projection lenses may comprise a three-piece liquid crystal display (3LCD) projection lens. The 3LCD projection lens uses LCD panels to modulate light signals emitted by a light source to accurately project a color of the projection image. The 3LCD modulation needs to separate the light signals of the light source, and the light signals of the light source can be separated into red (R), green (G), and blue (B) signals. The three colors of R (red), G (green), and B (blue) signals are modulated through three LCDs, and each color signal corresponds to one LCD. The three colors signal are synthesized into an image color of the projection image after modulating. Therefore, the 3LCD projection lens has characteristics of low power consumption and miniaturization, which can greatly improve a quality of the projection image.

In one embodiment, the vehicle entertainment system 30 further comprises a central control screen 31, and the projection image of the vehicle entertainment 30 may be also displayed through the central control screen 31. The central control screen 31 can display the projection image under a control of an image processor and a control chip to enhance an experience of video/image play. Cables and connectors conforming to a test specification of OPEN Alliance TC9 are used to connect the vehicle terminal 10 and the vehicle entertainment system 30 to realize a communication function between the vehicle terminal 10 and the vehicle entertainment system 30. The test specification supports unshielded and shielded twisted pair cable and connectors, and the signal transmission quality between the vehicle terminal 10 and vehicle entertainment system 30 can be guaranteed.

In one embodiment, in the on-board projection system 100, the mobile terminal 60 is communicated with the vehicle terminal 10, and the vehicle terminal 10 is communicated with the projection component 20, and the vehicle terminal 10 is further communicated with the vehicle entertainment system 30, to achieve the communication connections among the mobile terminal 60, the vehicle terminal 10, the vehicle entertainment system 30, and the projection component 20. The sensing component 50 is arranged inside of the vehicle, and the brightness of the projection image projected by the projection component 20 can be adjusted based on the detection result of the sensing component 50 to improve the viewing experience of the passengers. The projection image can be displayed on any one or more of the skylight 40, the vehicle window 42, the projection 43, and the central control screen 31 to meet the viewing requirements of different viewing angles. Finally, the viewing time can also be defined and adjusted, and problems of the visual fatigue and unable to relax by view the projection image on time can be avoided.

Even though information and advantages of the present embodiments have been set forth in the foregoing description, together with details of the structures and functions of the present embodiments, the disclosure is illustrative only. Changes may be made in detail, especially in matters of shape, size, and arrangement of portions within the principles of the present embodiments to the full extent indicated by the plain meaning of the terms in which the appended claims are expressed.

What is claimed is:

1. An on-board projection system, comprising:
a vehicle terminal;
a projection component communicated with the vehicle terminal;
a vehicle entertainment system communicated with the vehicle terminal, and the vehicle entertainment system being electrically connected to the projection component;
a display component electrically connected to the projection component; and
a sensing component,
wherein the display component is configured to display a projection image of the vehicle entertainment system, the sensing component is arranged on a side of the display component to detect an interior environment of a vehicle, and the projection component adjusts a display brightness of the projection image according to a detection result of the interior environment detected by the sensing component.

2. The on-board projection system of claim 1, wherein the vehicle terminal comprises a control unit, the control unit is electrically connected to the projection component, and the control unit is configured to control the display component to suspend displaying the projection image of the vehicle entertainment system according to a preset time rule.

3. The on-board projection system of claim 1, wherein the display component comprises a skylight, a vehicle window, and a projection screen, the projection component displays the projection image of the vehicle entertainment system through at least one of the skylight, the vehicle window, and the projection screen, and the sensing component is arranged on a side of the skylight or the vehicle window.

4. The on-board projection system of claim 1, wherein the projection component comprises a mounting base and a projector, the projector is arranged on the mounting base, and the mounting base is detachably arranged inside of the vehicle.

5. The on-board projection system of claim 4, wherein the projector comprises multiple projection lenses with different sizes, and each of the multiple projection lenses comprises a three-piece liquid crystal display projection lens.

6. The on-board projection system of claim 1, wherein the vehicle entertainment system comprises a central control screen, the projection component is further configured to display the projection image of the vehicle entertainment system through the central control screen.

7. The on-board projection system of claim 1, further comprising a mobile terminal, wherein the mobile terminal is communicated with the vehicle terminal, and the mobile terminal is configured to send the projection image to the vehicle terminal.

8. A vehicle comprising an on-board projection system, the on-board projection system comprising:
a vehicle terminal;
a projection component communicated with the vehicle terminal;
a vehicle entertainment system communicated with the vehicle terminal, and the vehicle entertainment system being electrically connected to the projection component;
a display component electrically connected to the projection component; and
a sensing component,
wherein the display component is configured to display a projection image of the vehicle entertainment system, the sensing component is arranged on a side of the display component to detect an interior environment of the vehicle, and the projection component adjusts a display brightness of the projection image according to a detection result of the interior environment detected by the sensing component.

9. The vehicle of claim 8, wherein the vehicle terminal comprises a control unit, the control unit is electrically connected to the projection component, and the control unit is configured to control the display component to suspend displaying the projection image of the vehicle entertainment system according to a preset time rule.

10. The vehicle of claim 8, wherein the display component comprises a skylight, a vehicle window, and a projection screen, the projection component displays the projection image of the vehicle entertainment system through at least one of the skylight, the vehicle window, and the projection screen, and the sensing component is arranged on a side of the skylight or the vehicle window.

11. The vehicle of claim 8, wherein the projection component comprises a mounting base and a projector, the projector is arranged on the mounting base, and the mounting base is detachably arranged inside of the vehicle.

12. The vehicle of claim 11, wherein the projector comprises multiple projection lenses with different sizes, and each of the multiple projection lenses comprises a three-piece liquid crystal display projection lens.

13. The vehicle of claim 8, wherein the vehicle entertainment system comprises a central control screen, the projection component is further configured to display the projection image of the vehicle entertainment system through the central control screen.

14. The vehicle of claim 8, wherein the on-board projection system further comprises a mobile terminal, the mobile terminal is communicated with the vehicle terminal, and the mobile terminal is configured to send the projection image to the vehicle terminal.
